(19) United States
(12) Patent Application Publication
(10) Pub. No.: US 2024/0331469 A1
(43) Pub. Date: Oct. 3, 2024

(54) Method for Restricting Access to Rented Astronomical Equipment

(71) Applicants: Jonathan Moshe, Laguna Niguel, CA (US); Michelle Moshe, Laguna Niguel, CA (US)

(72) Inventors: Jonathan Moshe, Laguna Niguel, CA (US); Michelle Moshe, Laguna Niguel, CA (US)

(21) Appl. No.: 18/583,856

(22) Filed: Feb. 21, 2024

Related U.S. Application Data
(60) Provisional application No. 63/447,632, filed on Feb. 22, 2023.

(51) Int. Cl. G07C 9/00

(52) U.S. Cl. CPC G07C 9/00174; G07C 2209/02

(57) ABSTRACT

A method for restricting access to rented astronomical equipment is provided. The disclosed method enables an owner or host to be completely hands-off, and allows one or more guests to use the complicated equipment in an easy manner, all by themselves, without interaction with the owner, host, or any other skilled user outside of the group of guests. The disclosed invention includes exposing a user to an instructional media and upon confirming the user's completed exposure with the instructional media, granting access to the observatory and telescope.

### CROSS REFERENCE TO RELATED APPLICATIONS

This application is a non provisional that claims priority from a provisional U.S. patent application No. 63/447,632 filed on Feb. 22, 2023.

### FIELD OF THE INVENTION

Embodiments of the invention generally relate to astronomical equipment. More specifically, embodiments of the invention relate to a method for providing rental astronomical equipment, namely an observatory and telescope.

### BACKGROUND OF THE INVENTION

Astronomical observatories, or simply referred to as observatories in this document, are typically complex structures built around telescopes. They come in all shapes and sizes and most of the famous ones are very big and available to the public as an attraction, such as the Griffith Observatory in Los Angeles, CA, or the Keck Observatory in Hawaii. However, many amateur astronomers also place small ones in the backyards, perhaps the size of garden sheds. The observatories can be manually operated, such as pushing the dome/roof around by hand, or they can be fully automated with electronics.

Due to their complex nature and expensive and sensitive equipment inside observatories, owners do not typically let unauthorized or unsupervised guests or the general public inside. Several owners have made their observatories available for rent, but all require an authorized operator or the owner to be present with paying guests. The authorized users may include the owner, someone the owner trusts, someone the owner has trained, etc.

As of now, no one provides a fully equipped and fully automated observatory and telescope available to the public to rent for private usage, without a host, owner, or trained professional on site. This is because a fully automated observatory and telescope is very complex and require a lot of interaction with the owner or trained professional.

Although this is not the only market contemplated by this disclosure, the short-term rental market, such as AirBnB, VRBO, etc, is an ideal market for a fully-automated observatory and telescope. However, most owners try to be hands off with these investments, and catering to unknown guests using their observatory and telescope would be a tedious, time-consuming, and challenging experience, one which may not make financial sense to the owner. Also, most short-term rental guests do not want any interaction with the owners when booking a private stay.

Observatories available for rent exist in the rental market. One of the most common observatory rentals is a remote observing site (ROS), and there are many of them. One example is the Sierra Remote Observatories (https://www.sierra-remote.com/). These ROS's are generally placed in very dark locations and are on the market for amateur astronomers to rent and place their equipment inside. The astronomers would then control their telescopes remotely, through a computer, from their own homes. The owner of the ROS usually provides some security of the equipment inside, and can tend to the equipment as needed when contacted by the owners of the equipment. No instruction is usually provided here, as the ROS owner simply provides empty space in his observatory for rent.

Other examples of rental observatories include:
“Home with Observatory” (https://www.airbnb.com/rooms/40308327) is available on AirBnb, but provides an empty observatory and advertises, “Astronomers bring your own telescope and use the observatory during your stay.” Note that while there are other observatories on this property that house equipment, they belong to the owner, are not available to rent, and guests are not given access to these observatories unless the owner is present and invites guests to join him.
Observer's Inn (https://www.observersinn.com) has rooms for rent and also provides an outdoor observatory (no structure) as an amenity. However, the owner welcomes the guests and provides a star show for them, and invites them to also bring their own telescopes. The guests do not experience a fully private experience as other guests are also allowed to join whether or not they are lodging at the property.
Skywatch Observatory Domestays (https://www.airbnb.com/rooms/451998) is similar to above, but has a dome structure. Guests do not experience self-use of the observatory as the owner/host provides a guided tour of the night sky for them.

Therefore, a need exists to make the operation of a complex automated observatory easy enough for any guest with or without experience to operate, without any interaction with the owner or authorized operator.

### SUMMARY OF THE INVENTION

A method for restricting access to rented astronomical equipment is provided. The disclosed method enables an owner or host to be completely hands-off, and allows one or more guests to use the complicated equipment in an easy manner, all by themselves, without interaction with the owner, host, or any other skilled user outside of the group of guests. In other words, an owner can feel secure in that their rented astronomical equipment will be safe. After a guest is exposed to instructional media, they will know how to operate a fully automated observatory and telescope, something they did not know how to do beforehand. The disclosed method applies to astronomy equipment, namely an observatory and telescope, rented to an untrained individual or group of people without the need for human interaction.

Method for restricting access to an observatory and telescope is provided. The invention includes exposing a user to an instructional media and upon confirming the user's completed exposure with the instructional media, granting access to the observatory and telescope. Confirming the user's completed exposure to the instructional media can be accomplished by having the the user demonstrate knowledge gained or submit a code gained from the instructional media. The instructional media can be in the form of a video recording or readable material. Granting access to the observatory and telescope can be via an entry code for the observatory, an initialization of telescope operating software, an initialization of the telescope.

### BRIEF DESCRIPTION OF THE DRAWINGS

FIG. 1 is an example of a telescope.

FIG. 2 is an example of a manual mount.

FIG. 3 is an example of an electric mount.

FIG. 4 is an example of an observatory.i

FIG. 5 is an instructions checklist posted next to the rental equipment.

FIG. 6 is a software screenshot configured for the rental equipment.

### DESCRIPTION OF THE INVENTION

Reference will now be made in detail to the present embodiments discussed herein, illustrated in the accompanying drawings. The embodiments are described below to explain the disclosed invention by referring to the Figures using like numerals. It will nevertheless be understood that no limitation of the scope is thereby intended, such alterations and further modifications in the illustrated invention, and such further applications of the principles as illustrated therein being contemplated as would normally occur to one skilled in the art to which the embodiments relate.

A method for restricting access to rented astronomical equipment is provided. The disclosed method enables an owner or host to be completely hands-off, and allows one or more guests to use the complicated equipment in an easy manner, all by themselves, without interaction with the owner, host, or any other skilled user outside of the group of guests. In other words, an owner can feel secure in that their rented astronomical equipment will be safe. After a guest is exposed to instructional media, they will know how to operate a fully automated observatory and telescope, something they did not know how to do beforehand. The disclosed method applies to astronomy equipment, namely an observatory and telescope, rented to an untrained individual or group of people without the need for human interaction.

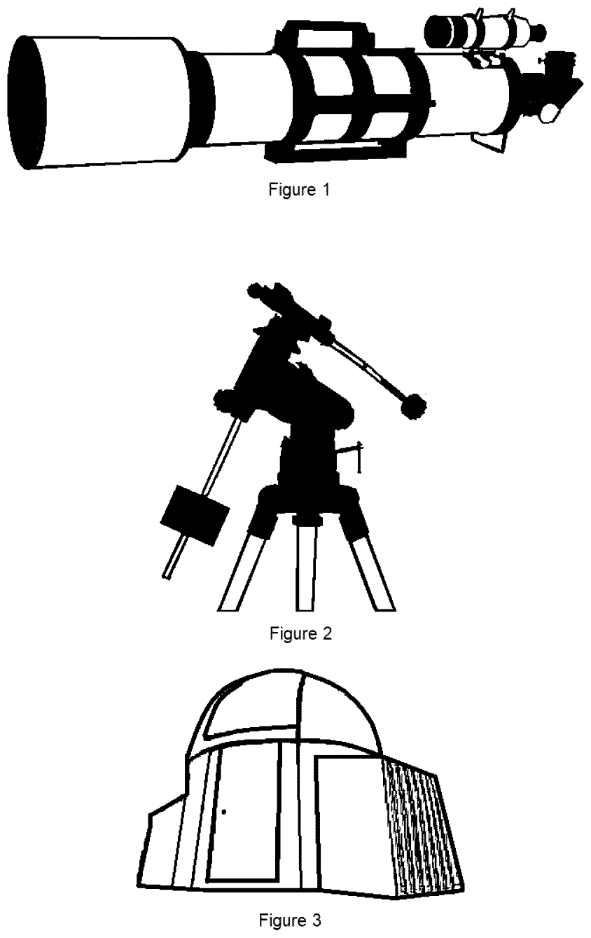

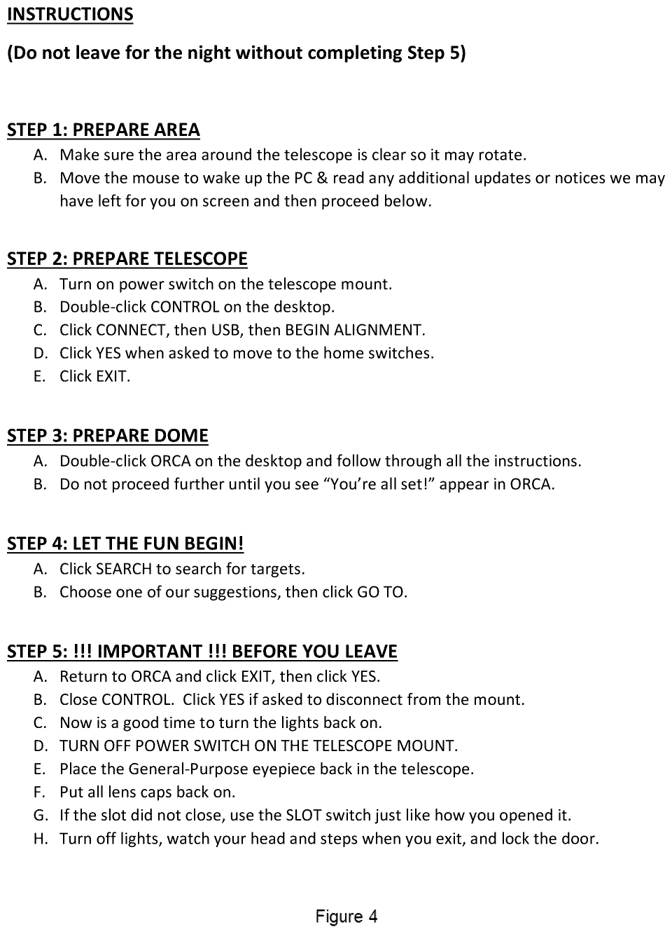

As illustrated in FIGS. 1-4, astronomy equipment consists of the telescope, telescope's electronic mount, telescope's manual mount, observatory, observatory's electronic control panel, and/or observatory's manual control system such as hand cranks. The operation of such equipment is not intuitive and generally requires a skilled professional to operate or guide an inexperienced user.

In order to obtain access to the astronomy equipment, the user is exposed to a form of media which covers some or all of the following:
Safety
Rules
Instructions on how to use the equipment
Limitations of the equipment, such as weather, time of day, etc.
Examples of the equipment in action
Examples of possible malfunctions and how to respond to them
Troubleshooting
Basic observing tips
Observing expectations

This exposure to the media includes watching, listening to, or reading the media. The media can also include a software application tutorial that educates and teaches the user. Various means to confirm that the user has successfully completed the exposure to the media can be utilized. The user may be required to demonstrate the acquired learning through a test, written or performance based. The test could be through a software tutorial or other means. The user may be required to utilize some form of code embedded throughout the media. Other confirmation means may be utilized and no limitation is intended. After confirmation, the user can be granted access to the equipment.

Means of access to the observatory can include a keypad code, instructions where to find a key, instructions how to otherwise gain entry or access to the equipment, or simply the owner's written or verbal permission to use the equipment after exposure to the media. Alternatively, it could be access to software that operates the telescope or the initialization of the telescope itself. It should be understood that access is defined as the ability or permission to operate the astronomical equipment, not access to the inside of the observatory, though that may be included and necessary.

Inside the observatory, the user may follow instructions or a checklist on how to initialize and/or set up the astronomy equipment. These instructions were learned during the initial exposure to the media and may additionally be made available closer to the equipment for convenience and to refresh the user's memory. Alternatively, this may be the guests' first and only exposure to instructional media. For example, this may include:
A checklist on the wall next to the computer or on the computer as illustrated in FIG. 5.
Another copy of media that the user was earlier exposed to.
A digital copy of any of the above media made available on a mobile device.
Labels on each individual eyepiece informing the user what focus setting to use on the telescope. This is information not currently found on eyepieces because they are meant to be swapped between telescopes and would require different focus settings per telescope. By providing these labels, novices are easily able to achieve proper focus with the optics.
Labels on each individual eyepiece informing the user what magnification is achieved. This is information not currently found on eyepieces because they are meant to be swapped between telescopes and the magnification is determined in combination with the focal length of the telescope. Since there is only one telescope on site, the magnification levels are known and labeled on the eyepieces which educates the novice users exactly how deep into space they are looking.
   These labels, checklists, and instructions reinforces the user's understanding and knowledge of operating the astronomy equipment that was gained during the exposure to media.

While initializing the astronomy equipment, computer software may be used to guide the user through the initialization process. Computer software, which may also be referred to or described as a program, software, a software application, an app, a module, a software module, a script, or code, can be written in any form of programming language, including compiled or interpreted languages, or declarative or procedural languages; it can be deployed in any form, including as a stand-alone program or as a module, component, subroutine, or other unit suitable for use in a computing environment deployed or executed on one or more computers. Alternative computer hardware implementations or hardware software combinations are also contemplated.

The disclosed method includes a software application, Observatory Retreat Control App, or ORCA, to achieve this purpose. This software is configured to the specific rented equipment, and is unlike 3rd-party generic software that can be used anywhere else. When launching the software, users may be forced to go thru a tutorial that walks them through the equipment startup. This tutorial is “smart”, meaning that it is not simply a list of actions and instructions to follow, but also includes equipment monitoring and feedback. For example, it will ask the user to turn on the telescope mount's power switch, and it will monitor the switch and not let the user proceed further until the action is completed. Another example is that it will open the dome automatically for the user during the tutorial, but if it detects the dome did not open, it will prompt the user on a corrective action. The software's tutorial can in some embodiments be more like a “helping hand”, rather than a set of instructions. In some embodiments, the tutorial may be the user's first and only exposure to instructional media.

The software can provide specific initialization instructions and safety information for the astonomical equipment. The software can take the user step-by-step through any instructions specific to setting up the equipment being used, such as:
showing a picture of the actual control panel in the observatory and highlighting exactly which button to press to perform a given task as illustrated in FIG. 6.
showing a picture of the power switch on the equipment and instructing the user when to toggle it.
showing a picture of the telescope's focus knob and instructing the user how to operate it.
instructing the user what to do in case of a malfunction or emergency.
instructing the user how to operate secondary/auxiliary equipment in the observatory, such as music or lighting.

The software may be configured to prompt the user throughout the night with repeating reminders how to shut down the equipment, or where to go for help, or where to read about viewing tips & tricks, etc. These are things that were learned in the tutorial, and is beneficial for users who have never operated equipment like this and have been taught quickly how to do it on their own. The reminders act as learning enforcement through the technique of repetition.

The software performs additional functions such as:
providing a list of customized suggestions of what to look at in the sky (known as targets), along with the time window at which they are visible.
providing suggested troubleshooting tips based on detected/sensed events, or as preventative tips explained during the initial orientation instructions.

Some of the disclosed features and functions may already exist in other 3rd-party generic software, but have not been implemented or combined together in any software, such as ORCA, customized to observatory and telescope rentals as described above.

The method covered by this patent transforms someone who has no prior knowledge of astronomical equipment into someone who is able to operate a fully-automated telescope and observatory safely and confidently all on their own, without help from the owner or anyone else. In an industry such as short-term rentals (Airbnb, VRBO, etc.), this is extremely important for the owners/hosts because they are not usually available at all times of the night to interact with their guests and strive to be as hands-off as possible. It is equally important to the guests because they don't usually want any interaction with their hosts, and they want everything to be easy and trouble-free during their stay. This method can make an astronomer out of anyone, whether they have prior experience or not.

The preceding description contains embodiments of the invention and no limitation of the scope is thereby intended. It will be further apparent to those skilled in the art that various modifications and variations can be made in the present invention without departing from the spirit or scope of the invention.

1. Method for restricting access to an observatory and telescope comprising:
Exposing a user to an instructional media;
Upon confirming the user's completed exposure with the instructional media, granting access to the observatory and telescope.

2. The method of claim 1 wherein confirming the user's completed exposure to the instructional media involves the user demonstrating knowledge gained.

3. The method of claim 1 wherein confirming the user's completed exposure to the instructional media involves the user submitting a code gained from the instructional media.

4. The method of claim 1, wherein the instructional media is a video recording.

5. The method of claim 1, wherein the instructional media is readable material.

6. The method of claim 1, wherein granting access to the observatory and telescope is via an entry code for the observatory.

7. The method of claim 1, wherein granting access to the observatory and telescope is via an initialization of telescope operating software.

8. The method of claim 1, wherein granting access to the observatory and telescope is via an initialization of the telescope.

9. The method of claim 10 further comprising:
Upon confirming the user's completed exposure with the instructional media, but before granting access to the observatory and telescope, exposing the user to a reinforcing form of instructional media.

10. Method for restricting access to an observatory and telescope comprising:
Exposing a user to an instructional media;
Upon confirming the user's completed exposure to the instructional media, granting access to the telescope.

11. The method of claim 10 wherein confirming the user's completed exposure to the instructional media involves the user demonstrating knowledge gained.

12. The method of claim 10 wherein confirming the user's completed exposure to the instructional media involves the user submitting a code gained from the instructional media.

13. The method of claim 10, wherein the instructional media is a video recording.

14. The method of claim 10, wherein the instructional media is readable material.

15. The method of claim 10, wherein granting access to the telescope is via an entry code for the observatory.

16. The method of claim 10, wherein granting access to the telescope is via an initialization of telescope operating software.

17. The method of claim 10, wherein granting access to the telescope is via initialization of the telescope.

18. The method of claim 10 further comprising:
Upon confirming the user's completed exposure to the instructional media, but before granting access to the telescope, exposing the user to a reinforcing form of instructional media.

19. Method for restricting access to an observatory and telescope comprising:
Exposing a user to an instructional media;
Upon confirming the user's completed exposure to the instructional media, granting access to the observatory;
In the observatory, exposing the user to a reinforcing instructional media;
Upon confirming the user's completed exposure to the reinforcing instructional media, granting access to the telescope.

20. The method of claim 19, wherein granting access to the telescope is via initialization of the telescope.
